(19) United States
(12) Patent Application Publication
(10) Pub. No.: US 2006/0240394 A1
(43) Pub. Date: Oct. 26, 2006

(54) Examination simulation system and method

(75) Inventors: Dan Charles Smith, Gurnee, IL (US); Craig B. Watters, Evanston, IL (US)

Correspondence Address: FOLEY & LARDNER LLP, 150 EAST GILMAN STREET, P.O. BOX 1497, MADISON, WI, 53701-1497, US

(73) Assignee: Management Simulations, Inc.

(21) Appl. No.: 11/110,648

(22) Filed: Apr. 20, 2005

(51) Int. Cl. G09B 3/00; G09B 7/00

(52) U.S. Cl. 434/322; 434/350

(57) ABSTRACT

A system is provided that enables the administration of an examination, which utilizes a simulation, to a plurality of examinees. The system includes a first device and a second device in communication using a network. An examination delivery program executes at the first device to create the examination questions dynamically, and an examinee interface application executes at the second device to present the examination questions to the examinee for an answer. The examination delivery program grants an examinee access to an examination selected for the examinee based on examinee information entered by the examinee, creates a simulation for the examinee based on the selected examination, presents a situation to the examinee using the simulation, requests an examinee decision relative to the situation, executes the simulation using the examinee decision as an input thereby calculating a result, executes a question subprogram using the calculated result thereby defining a question, sends the question to the examinee, and receives an answer to the question from the examinee.

### BACKGROUND OF THE INVENTION

1. Field of the Invention

The present invention relates generally to examination and training systems and methods. More specifically, the present invention relates to examination and training systems and methods that use simulation.

2. Description of the Related Art

This section is intended to provide a background or context. The description herein may include concepts that could be pursued, but are not necessarily ones that have been previously conceived or pursued. Therefore, unless otherwise indicated herein, what is described in this section is not prior art to the claims in this application and is not admitted to be prior art by inclusion in this section.

Conventional systems and methods for conducting examinations and testing of students and employees have several significant drawbacks. For example, conventional examinations utilize the same questions for all students. As such, students can copy answers from other students or, in the case where examination questions are re-used, obtain the questions and answers before the examination is administered. For example, copies of college examinations are often in the file cabinets of local fraternities for reference by future fraternity members. Additionally, both traditional paper examinations and online tests have become increasingly difficult to secure. Online teaching environments, in particular, present special problems because it is easy for students to share answers.

Some examinations attempt to prevent students from copying answers from other students by arranging questions in different orders for different students. Although direct copying may be prevented, the examination questions and answers are still the same for all students taking the test regardless of when the test is taken. Thus, if the student is familiar with the questions before the examination, the correct answer can still be memorized and selected despite the change of order of questioning. Conventional examinations also tend to test certain types of knowledge, such as the recall of memorized facts, more than they test analysis and problem solving. Thus, there is a need for a system and a method to improve the testing of students. Further, there is a need to make each examination unique to reduce the ability of examinees to cheat while maintaining a fair examination such that the difficulty level is the same for all examinees. Even further, there is a need for a system and a method of conducting examinations that test judgment and analytic skills, such as those needed by graduates of business schools.

### SUMMARY OF THE INVENTION

In general, the present invention relates to an examination system that improves the testing of students, that reduces the ability of an examinee to cheat on the examination, and that provides a consistent difficulty level for all examinees. In an interactive simulation, each student makes decisions that, through interaction with the student's simulated world, produces an outcome that is unique to the student. A second student using the same interactive simulation makes different decisions that produce a similar, but unique result for the second student. The invention generates similar, but unique examination questions for the first and second student utilizing the unique conditions in the simulation executing for each student. Thus, the questions generated for each student's examination have a common conceptual structure, but because each set of decisions and the resulting simulated outcomes are unique to the student, each question also is made unique to the student. Because each student's examination is unique, it is difficult to cheat, even in an online environment. The examination remains fair because each student is presented with the same questions conceptually. Further, the invention assesses judgment and analytical skills by asking the examinee to examine the decisions and outcomes in the simulation. The student can be asked why a choice was made, or why an outcome was reached, while framing the question in a way that is both unique and fair.

For example, using a business simulation, each student may decide a price for their product, design specifications for their product, and a production quantity and, from these parameters, the business simulation determines production costs. A question about “break even” is stated the same for all students, “What was break even for your product last year?” The possible answers presented to each student, however, depend on the student's decisions for price, design specifications, and production quantity. From a conceptual standpoint, the question is the same as that posed to classmates, but the answer is unique to the student's simulation.

An interactive simulation can be frozen at any point (checkpoint) so that a number of questions can be defined such that the examinee can be questioned about the current situation in the simulation. This capability can be used to support short tests or quizzes that focus on specific content areas instead of one long examination. Alternatively, a long examination can be segmented into a number of quizzes such that each quiz utilizes a separate simulation execution to define a series of questions. The existing state of the simulation, in addition to examinee decision information, may be used for each simulation execution or a new simulation state may be defined using simulation parameters specific to the quiz. As yet another alternative, the simulation may be executed to define each question in an examination or quiz. For example, in a business simulation the first quiz might focus on accounting and the second quiz might focus on marketing thereby allowing the administrator to evaluate a variety of content areas.

Unlike real world training activities, interactive simulations can record decisions made by examinees. An examination using an interactive simulation can capture decisions, simulator outcomes, and quiz results into a database making it possible to assess the learning of an individual or an entire population. For example, a school might evaluate its students to meet an assurance of learning standard.

The terms examinee and student are used interchangeably to identify a person taking the examination. The terms examiner is used to identify the person or persons creating, scheduling, and/or delivering the examination.

An exemplary embodiment relates to a device, a method, and a computer readable medium for conducting an examination that utilizes a simulation. The method includes, but is not limited to, granting an examinee access to an examination selected for the examinee based on examinee information entered by the examinee, the examination including a question subprogram; creating a simulation for the examinee based on the selected examination; presenting a situation to the examinee using the created simulation; requesting an examinee decision relative to the presented situation; executing the created simulation using the examinee decision as an input thereby calculating a result; executing the question subprogram using the calculated result thereby defining a question; sending the defined question to the examinee; and receiving an answer to the sent question from the examinee, the answer selected by the examinee.

Another exemplary embodiment relates to a device, a method, and a computer readable medium for taking an examination utilizing a simulation. The method includes, but is not limited to, sending examinee information from an examinee to an examination delivery program, wherein an examination is selected based on the examinee information; presenting a situation to the examinee, wherein the situation is created by the examination delivery program using a simulation, the simulation created based on the selected examination; sending an examinee decision to the examination delivery program, wherein the examinee decision is a response to the situation; receiving a question from the examination delivery program, the question defined by the examination delivery program through execution of a question subprogram, wherein execution of the question subprogram uses a result calculated by the simulation using the examinee decision as an input; presenting the received question to the examinee; and sending an answer to the presented question to the examination delivery program.

Another exemplary embodiment relates to a system enabling an administration of an examination, which utilizes a simulation, to a plurality of examinees. The system includes, but is not limited to, a first device and a second device in communication using a network. The first device includes, but is not limited to, an examination delivery program. The examination delivery program includes computer code to grant an examinee access to an examination selected for the examinee based on examinee information entered by the examinee, the examination including a question subprogram; to create a simulation for the examinee based on the selected examination; to present a situation to the examinee using the created simulation; to request an examinee decision relative to the presented situation; to execute the created simulation using the examinee decision as an input thereby calculating a result; to execute the question subprogram using the calculated result thereby defining a question; to send the defined question to the examinee; and to receive an answer to the sent question from the examinee.

The second device includes, but is not limited to, an examinee interface application. The examinee interface application includes computer code to send the examinee information from the examinee to the examination delivery program; to present the situation to the examinee; to send the examinee decision to the examination delivery program; to receive the defined question from the examination delivery program; to present the received question to the examinee; and to send the answer to the presented question to the examination delivery program.

Another exemplary embodiment relates to a device, a method, and a computer readable medium for creating a dynamic question used in an examination utilizing a simulation. The method includes, but is not limited to, developing a question subprogram for a question, testing the question subprogram using a standardized development scenario to define a question, validating the question subprogram based on a validation of the defined question, and if the question subprogram is validated, storing the question subprogram in a database. The question subprogram creates the examination question using results calculated through execution of a simulation. The results are inserted in the question during the examination.

Another exemplary embodiment relates to a device, a method, and a computer readable medium for creating an examination that utilizes a simulation. The method includes, but is not limited to, selecting an examination question from a database including a plurality of examination questions, and adding the examination question to an examination template based on an evaluation of the examination question. The examination question is defined using a question subprogram. The question subprogram creates the examination question using results calculated through execution of a simulation.

Other principal features and advantages of the invention will become apparent to those skilled in the art upon review of the following drawings, the detailed description, and the appended claims.

### BRIEF DESCRIPTION OF DRAWINGS

Exemplary embodiments will hereafter be described with reference to the accompanying drawings, wherein like numerals will denote like elements.

FIG. 1 is an overview diagram of an examination simulation system in accordance with an exemplary embodiment.

FIG. 2 is a functional block diagram of the examination simulation system of FIG. 1 in accordance with an exemplary embodiment.

FIG. 3 is a functional block diagram of an examination delivery program in accordance with an exemplary embodiment.

FIG. 4 is a flow diagram depicting an examination delivery process in accordance with an exemplary embodiment.

FIG. 5 is a flow diagram depicting an examination process in accordance with an exemplary embodiment.

FIG. 6 is a flow diagram depicting a process for creating an examination question subprogram in accordance with an exemplary embodiment.

FIG. 7 is a flow diagram depicting a process for creating an examination in accordance with an exemplary embodiment.

FIG. 8 is a block diagram of a device for implementing the examination delivery process of FIG. 4 and/or an examination analysis process.

FIG. 9 is a block diagram of a device for implementing the examination process of FIG. 5.

FIG. 10 is a block diagram of a device for implementing the processes of FIGS. 6 and 7.

### DETAILED DESCRIPTION OF EXEMPLARY EMBODIMENTS

A classic examination has several goals: First, an examination checks understanding and accuracy within subject matter areas. Second, an examination standardizes across all students that take it. Third, an examination measures results and sets a grading threshold, including ratings such as “A, B, C”. In contrast, example simulation goals include measuring operating effectiveness (e.g., can you produce a profit?), presenting problems and exploring possible reactions (e.g., “Your competitor has introduced a new product. How should you react?”), and tolerating, if not encouraging, failure or risk taking. One premise in using a simulation is to crash and burn in the simulation, and not in the real world, thereby allowing the student to test the boundaries. Additionally, simulations provide effective teaching devices because students tend to remember more of what they learn if they are “doing the real thing” through a simulation. Simulations also strive to develop an understanding of processes that occur over time given a set of input conditions, a faster than real time simulation of the process, and a subsequent discussion and review of the simulation results. For example, students run simulations to learn how to solve complex problems that may not have a single correct answer and that may exhibit complex cause and effect relationships. Example simulation environments include a marketplace, an engineering project, a business, etc. Within a business simulation, the simulation may evaluate the following issue areas: research and development, marketing, production, labor, total quality management, finance, balance sheet, income statement, cash flow, performance ratios, marketing reports, decision summaries, etc.

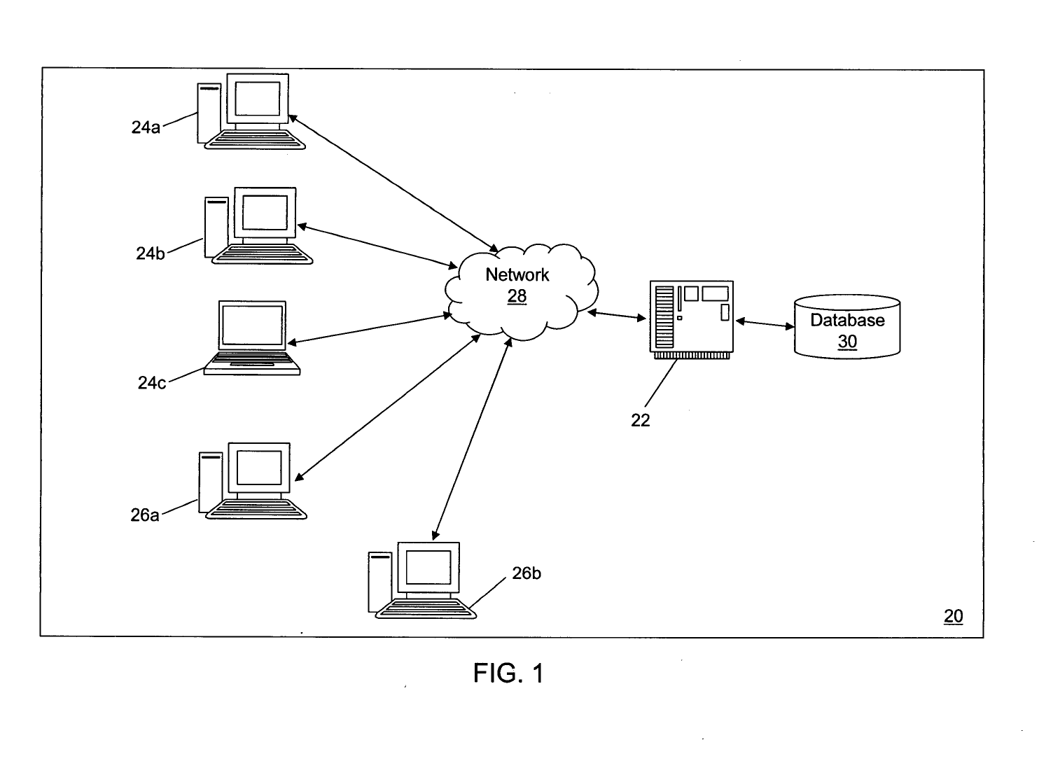

FIG. 1 illustrates an examination simulation system 20 in an exemplary embodiment. The examination simulation system 20 includes a first device 22, a plurality of examinee devices 24a-24c, a plurality of examiner devices 26a, 26b, a network 28, and a database 30. In general, the first device 22 can include a laptop, a desktop, or any other type of computer. The system 20 may include a plurality of first devices having a single or multiple processors. The plurality of examinee devices 24a-24c and the plurality of examiner devices 26a, 26b can include a laptop, a desktop, or any other type of computer, an integrated messaging device, a cellular telephone, a personal digital assistant, etc. The network 28 provides communication between the first device 22, the plurality of examinee devices 24a-24c, and the plurality of examiner devices 26a, 26b using various transmission media that may be wired or wireless and may use various transmission technologies. The network 28 may include additional and possibly different devices that may be remote from each other or adjacent to each other. The system 20 may include any combination of wired or wireless networks. Thus, the network 26 may include sub-networks. The database 30 may be located in a memory included at the first device 22 or otherwise accessible from the first device 22 possibly through the network 28. The network 28 may include the Internet.

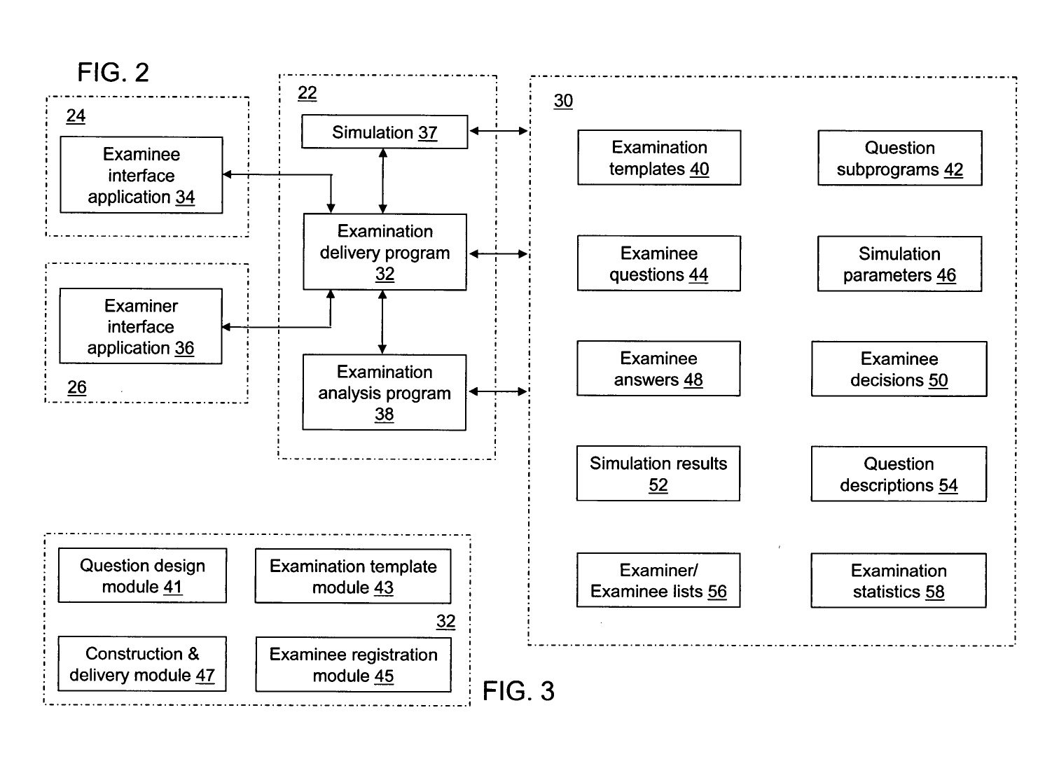

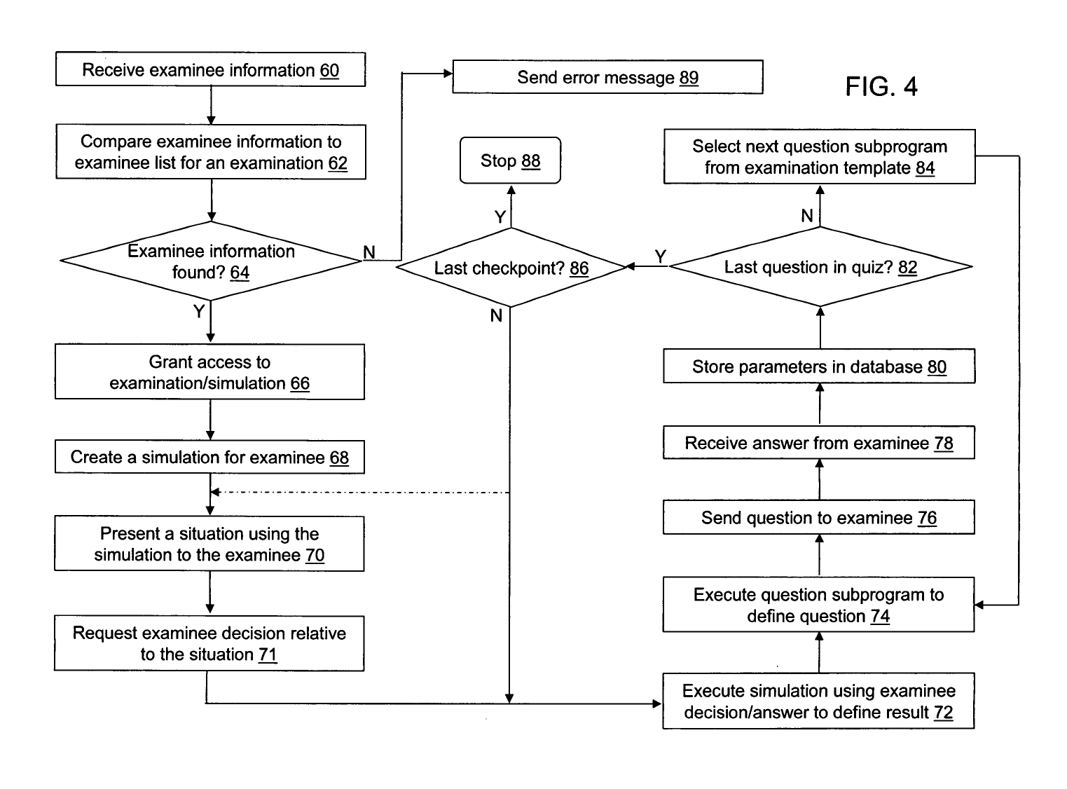

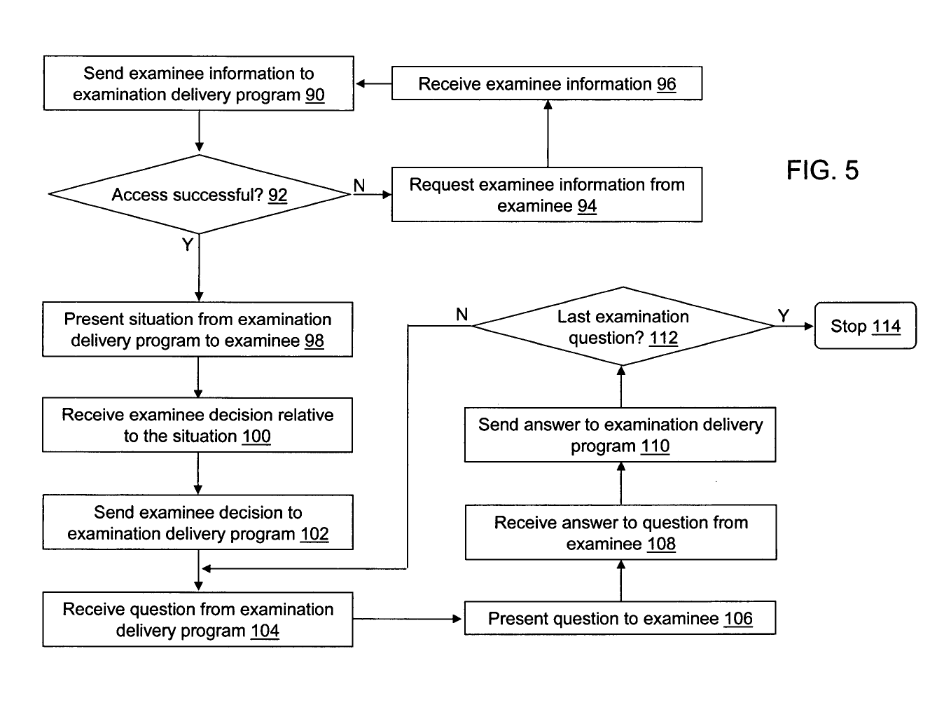

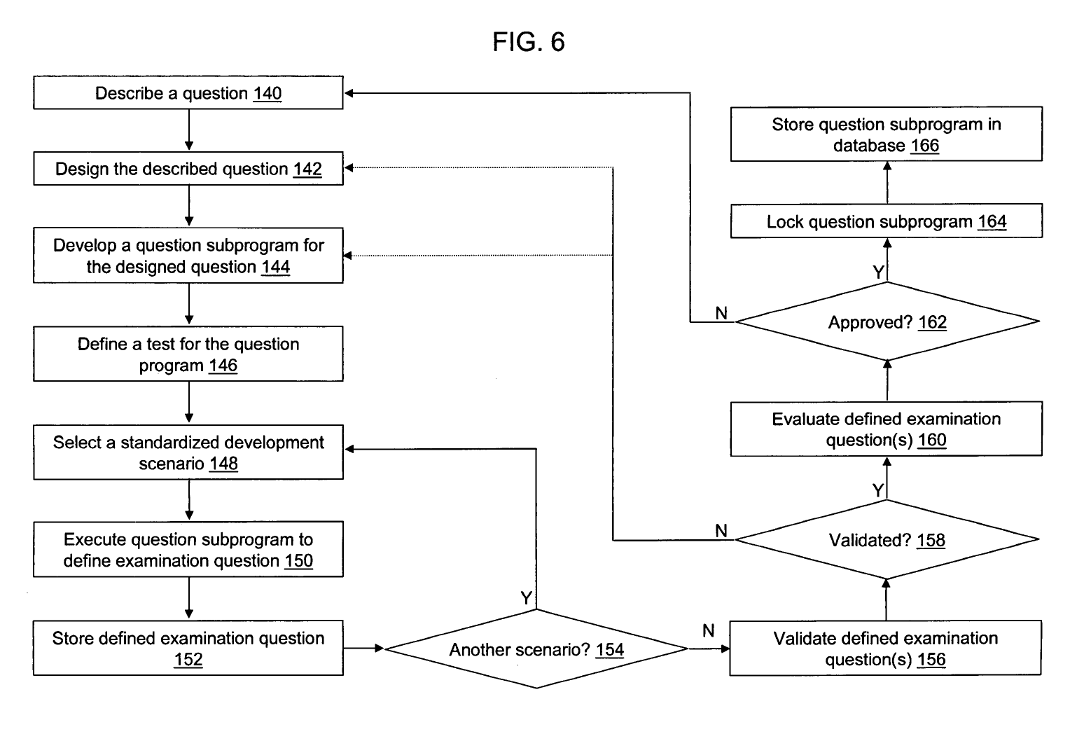

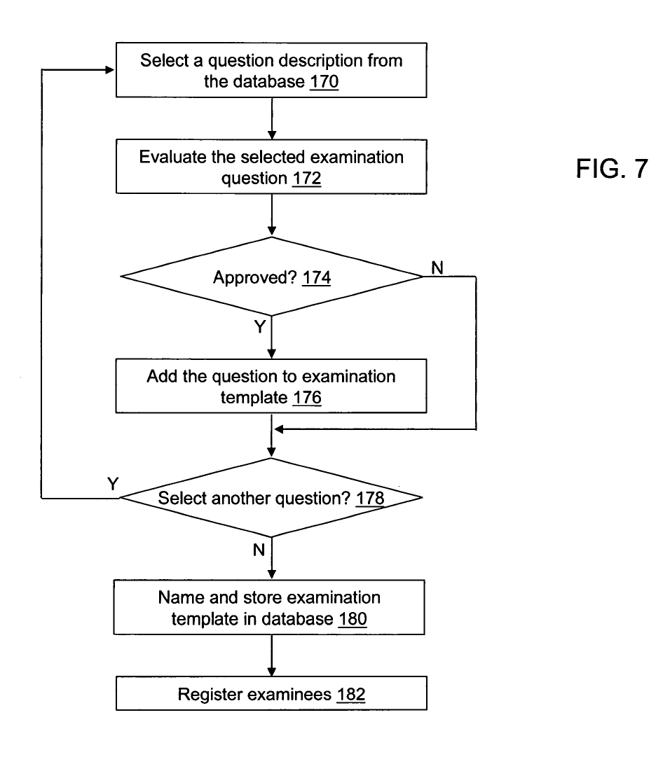

With reference to FIG. 2, the first device 22 performs the operations of an examination delivery program 32 (described with reference to FIG. 4), a simulation 37, and an examination analysis program 38. Each of the plurality of examinee devices 24a-24c performs the operations of an examinee interface application 34 (described with reference to FIG. 5). The examinee interface application 34 exchanges information with the examination delivery program 32 using the network 28 enabling administration of an examination, which utilizes the simulation 37, to a plurality of examinees of the examination simulation system 20. Each of the plurality of examiner devices 26a, 26b performs the operations of an examiner interface application 36 (described with reference to FIGS. 6 and 7) and exchanges information using the network 28 with the examination delivery program 32. The examination delivery program 32 sends information to be stored in the database 30 and receives information stored in the database 30. The examination delivery program 32 interacts with the simulation 37 to include the cause and effect relationships exhibited by a system through a simulation of the examination subject area. The simulation 37 may simulate a plurality of subject areas. For example, the simulation 37 may be a simulation of business management principles associated with marketing.

The simulation 37 may be part of the examination delivery program 32 or separate from the examination delivery program 32. If the simulation 37 is separate from the examination delivery program 32, the simulation 37 may be executed at the same or a different device in communication with the first device 22. Elements of the simulation 37, examination delivery program 32, examination analysis program 38, and database 30 can be combined or shared across the applications, and can be executed at the same or different times on the same or different devices.

The simulation 37 creates the scenario and data to be examined using decisions made by examinees during an examination. The examination delivery program 32 manages questions, question subprogram, examination templates, and delivers the tests to examinees. The examination analysis program 38 determines various statistical results relating to the examination and presents the results to examiners for review and analysis. The database 30 holds the information for conducting examinations, for executing the simulation 37, and the information related to completing examinations and extracting the information as requested by the examination delivery program 32, the simulation 37, and/or the examination analysis program 38. The database 30 may include a plurality of databases possibly maintained on different devices. The database 30 includes examination templates 40, questions subprograms 42, examinee questions 44, simulation parameters 46, examinee answers 48, examinee decisions 50, simulation results 52, question descriptions 54, examiner/examinee lists 56, examination statistics 58, and other information associated with creating and with taking examinations using the simulation 37. The database 30 may be organized to include one or more library such that a library may include links to other libraries. The libraries may be organized by topic, author, edition, etc. The library manages similar questions by pointing to related variations and descendants in threads. Thus, descendent questions that are variations of each other can be associated with each other. Additionally, the questions themselves may be organized by topic, author, edition, etc.

The simulation 37 creates a simulated environment from two types of information stored in database 30: the examinee decisions 50 and the simulation parameters 46. In an exemplary embodiment, the examinee uses the examinee interface application 34 to make decisions requested for the simulation 37. The examinee decisions 50 are sent through the network 28 to be stored in database 30. Simultaneously or at a deadline, the simulation 37 uses the simulation parameters 46 initially defined by the examiner when creating the examination and the examinee decisions 50 drawn from the database 30 to calculate a simulated result at a checkpoint in time, and stores the simulation results 52 to the database 30.

In an exemplary embodiment, an examinee takes the examination at one of the examinee devices 24a-24c through interaction with the examinee interface application 34. The examinee uses the examinee interface application 34 to make the examinee decisions 50 for the simulation 37. The examinee decisions 50 are stored to the database 30. At one or more checkpoints, execution of the simulation 37 halts to give the examinee a quiz. The examination delivery program 32 retrieves the examinee decisions 50 and simulation results 52 from the database 30 to compose unique examinee questions 44 and to construct the quiz, which the examinee at the examinee device 24a-24c accesses through the examinee interface application 34. The examinee answers 48 to the examinee questions 44 are stored in the database 38. The examiner uses the examination analysis program 38 to determine a quiz score, storing the scores in the database 38. When all of the examinees have finished the quiz, the examiner uses the examination analysis program 38 to calculate the examination statistics 58 that include the quiz scores for each examinee and other statistics calculated across the population of examinees.

In an exemplary embodiment that simulates businesses within an industry, each examinee participates in a simulation during their individual examination as chief executive officer of a business. Their simulation is “unique” in the sense that they do not compete directly with other examinees. Instead, they compete against a standardized set of competitors that always take the same action or make the same decision. Even so, because each examinee makes different decisions for their company, the numbers inside the simulation are unique to the examinee. For example, one examinee might price high, while another prices low. This response impacts the standardized competitors differently, producing a simulation outcome that is unique to the student. Additionally, randomness can be inserted into the simulation, for example by randomly changing the parameters over a limited range. The order of competitors may also change when the examinee's simulation begins, so although the competitors are always the same, they appear differently in the reports.

The examination delivery program 32 creates a complex environment where meaningful issues and questions can be raised with the examinee. The complex environment is explored through dynamic examination questions uniquely posed to each individual examinee and including content from the simulation 37. Thus, the testing context is unique for each student. The test questions and answers are made unique because the condition in the simulation 37 is unique to the student. An example question is, “Given profits of $400 and assets of $1000, what is the return on assets?” The profits and assets change for each student and are thus variable content included in the question. As a result, the question is conceptually the same, but the answer is different for each student. As a result, the answers from which the examinee selects also change. The wrong answers may include use of an algorithm to determine answers based on common mistakes made by examinees.

With reference to FIG. 3, the examination delivery program 32 can be partitioned into four modules: a question design module 41, an examination template design module 43, an examinee registration module 45, and an examination construction and delivery module 47. The database 30 stores the results from the four modules.

The question design module 41 is used by examiners to construct questions in preparation for future examinations. The question design module 41 stores the question descriptions 54 to the database 30. The question descriptions 54 are used primarily by future examiners to decide whether to include the question in their examination template. The description includes features like a unique identifier, a text description of the question and its purpose, and recommendations for usage of the question in an examination. The question design module 41 additionally includes the parameters and the question subprograms 42 to generate a unique iteration of the question for each examinee, using the examinee's simulation results. Both the question statement and the question answers are generated from the examinee's simulation results, and therefore reflect the unique situation in the simulation 37. For example, shown below are two results from a question subprogram that is generating a multiple choice question for two different students:

Student A. What is the breakeven for the Able product?
a. 192,392 units
b. 293,392 units
c. 394,923 units
d. 438,123 units

Student B. What is the breakeven for the Ace product?
a. 422,293 units
b. 392,198 units
C. 293,323 units
d. 193,932 units

In the examples above, the question subprogram selected different products and presented the answers in a random order. The numbers reflect different results within the two simulations. Additionally, the question subprogram calculated answers that reflect common mistakes by students as well as the correct answer allowing examiners to assess not only the percentage of students getting the answer correct, but also the frequency of common misunderstandings.

In general, a question consists of the text of the question and either an “Essay Response” or an “Answer List”. Essay Responses generally require a professor to grade each student's answer manually. Essay questions can have objectives ranging from evaluating the student's writing skills to assessing their thought processes. The examination simulation system 20 simply collects essays. It makes no attempt to score them. When a professor grades the essay, however, the examination simulation system 20 collects professor comments and a score. An essay question can present situations that occur within the simulation scenario. An example essay question is:
South Korean chaebol Goldstar is investigating our industry as an expansion opportunity. They are investigating acquisition targets. Write a 200 word position essay for your company to consider. Which company should they purchase? What makes that company most attractive?

A second essay question example is:
Last round your balance sheet presented a 60% debt 40% equity financial policy to investors. Write a 200 word position essay justifying your financial policy.

In an exemplary embodiment, “Answer List” questions are scored by the first device 22. Such questions can include a list of any number of responses from which the examinee selects one or more response. For example, in an exemplary embodiment, up to 20 possible responses can be presented for selection. For example, a True/False question uses the first two answers in the list and ignores the remaining 18. A multiple choice question may use the first four answers and ignore the rest. Alternatively, a multiple choice question can include one correct answer and 19 incorrect answers. The “Answer List” questions can include a “choose all that apply” question that presents 20 possibilities from which the student chooses all that apply. The “Answer List” questions can include a value for each answer. For example, the correct answer might be worth 10 points. In some questions like “choose all that apply”, an incorrect answer might have a negative value. In another type of question, the student selects appropriate points from a list of possibilities presented.

A true/false question can examine the student's simulated company or any competitor. For example, the question may be “Your Able product stocked out last round. Instead of 14.2% share in the traditional segment, you could have achieved 15.9% share. a. True, b. False.” The numbers 14.2% and 15.9% are simulation results inserted in the question based on execution of the associated question subprogram. As another example, the question may be “Erie Corporation is the cost leader in the traditional segment. (a) True (b) False.” Erie Corporation is a simulation result inserted in the question based on execution of the associated question subprogram. In some cases, the true answer may be inserted and in others a false answer possibly based on random selection for each examinee.

A multiple choice question can explore virtually any analytical problem. For example, the question may be “The Able product reached break even last round at how many unit sales? a. 147 thousand, b. 154 thousand, c. 193 thousand, d. 242 thousand.” As another example, the question may be “From a high performance customer's point of view, the Coat product's strongest selling point is its: a. Positioning, b. Awareness, c. Production capabilities, d. Price.”

As another example, the question “Review your competitor's financial statements. What factors contributed to their cost advantage relative to your products? Rank order the following possible causes” may be followed by a list of potential causes. The question is “intelligent” in the sense that it compares the examinee's results with competitors before posing the question.

In the following exemplary question, each answer is “correct”, but the student is challenged to pick the best solution. The best answer might be worth 10 points, the second best 7, the third best 3, and the least 0.
Assume that Ferris Corporation's board has placed a premium on improving ROE. Given Ferris's current balance sheet, which of these tactics would be best for Ferris: a. Buy back 20% of their outstanding stock, b. Issue a $5.24/share dividend, c. Issue $10M of debt and use the money to pay a $2.39/share dividend, d. Buy $15M additional plant funded entirely with new debt.

Advantageously, the student's exam is unique, making it difficult to cheat, even in an online environment. The exam is fair because each student faces the same set of questions. This combination of uniqueness and fairness addresses a real problem. For an online test designer, scrambling the order of answers or the order of questions helps some, but if students know the answer is “$3.29”, changing the order of answers does not help much. In the examination, the correct answer might be $3.15 for one student and $3.98 for another, even though the question posed was the same, because the answer depends on the current conditions inside the student's simulation.

The examination template design module 43 constructs examination templates developed by examiners. The database 30 may include any number of question descriptions 54. From a list of questions, an examiner might choose only 30 questions to present to examinees in an examination for which the examiner is preparing. The examination template design module 43 allows examiners to create a master examination template for the examination, which is named and stored in database 30. The database 30 can contain any number of examination templates 40. To create a new examination, the examiner uses the examination template design module 43 to select questions from the question descriptions 54 and to order them into a presentation list. The new examination template is given a unique identifier and stored in database 30.

The examinee registration module 45 creates a registration for students into the examination. An examination is an instance of an examination template that is given to a group of examinees at a chosen time. For example, an examiner might choose Template X from the database 30 and use it to schedule Examination X, an instance of Template X on March 20 at 3 PM for examinees in a particular class. A different examiner might also choose Template X to schedule Examination Y for a different group of examinees at a different time. After Examination X is created and scheduled, the module accepts registrations for examinees which uniquely link them to the Examination, for example X or Y, using unique student information that for example includes a user identifier and a password. The registrants for each examination are captured in examiner/examinee lists 56.

The examination construction and delivery module 47 creates each examinee's unique instance of the Examination. In an exemplary embodiment, Examinee 1 registers for Examination X. The questions for Examinee 1 are created at run-time from the unique simulation results for Examinee 1. From the viewpoint of Examinee 1, the system 20 presents a variation of Examination X, Examination X₁. From the viewpoint of Examinee 2, the system 20 presents a variation of Examination X, Examination X₂. Although Examination X₁ and Examination X₂ are constructed from the same Examination X, the questions can vary in many ways because the data referenced in the two simulations is unique. The examination is fair because the questions are the “same”, although they reference different data points within the examinee's simulation.

The examination analysis program 38 determines the correctness of the examinee answers 48, stores the determinations in the database 30, and develops statistics across a population of examinees and for an individual examinee. The system 20 can provide both automatic and manual methods for evaluating an examinee's answers. Once scored, the examination analysis program 38 develops statistics for each question, which may be limited to the examinees registered for that particular examination, or which could include every student that has ever responded to the question in any examination. Statistics about the questions include frequency of usage and the number of correct and incorrect responses. The examination analysis program 38 can optionally offer methods for the examiner to export the data from the system 20 to the examiner's device 26.

FIG. 4 illustrates an exemplary examination delivery process of the examination delivery program 32 executing at the first device 22. Additional, fewer, or different operations may be performed in the process depending on the embodiment. In an operation 60, the simulation is engaged when examinee information is received from the examinee. Identity and security issues are addressed through use of the examinee information. In an operation 62, the examinee information received is compared to examinee information associated with examinations during the registration process performed by the examiner. The registration process determine which, if any, examination the examinee is scheduled to take. In an operation 64, if the examinee information is not found associated with an examination, an error message is sent to the examinee in an operation 89. If the examinee information is found in the operation 64, the examination, for example Examination X, is selected from the database 30 based on the comparison with the examinee information. In an operation 66, the examinee is granted access to the examination and the simulation. Access to the simulation 37 may be granted through use of a key. The key for example may be a unique string created using the examinee information.

In an operation 68, an instance of the simulation 37 is created for the examinee. From the simulation, a situation is presented to the examinee in an operation 70. Additionally, in an operation 71, the examinee is requested to make decisions relative to the situation. For example, the situation may ask the examinee to define characteristics of their business such as a price, products, etc. In an operation 72, the simulation instance is executed using the examinee decision. In subsequent iterations, the simulation instance may be executed again using both the examinee decision and answers from previous questions. In an operation 74, the question subprogram executes to define the question. The question includes results determined from execution of the simulation instance in the operation 72. In an operation 76, the question is sent to the examinee device 24. In an operation 78, an answer is received from the examinee. In an operation 80, parameters are stored in the database 30. For example, the parameters may include, the examinee answer, the question, the examinee decision, the simulation result, the correctness of the examinee answer that may have been determined, etc.

Examiners may decide to stop the simulation at multiple points during the examination. These points are called checkpoints. Effectively, the examination is then divided into a quiz associated with each checkpoint. At each checkpoint, questions are defined and presented to the examinee without additional execution of the simulation instance. In an operation 82, if the current question is not the last question in the quiz, processing continues at an operation 84. In the operation 84, the next question subprogram associated with the next question in the quiz is selected from the examination template created by the examiner. Processing continues at the operation 74 to define the next question for the examinee. If the current question is the last question in the quiz, processing continues at an operation 86. In the operation 86, if the current checkpoint is not the last checkpoint defined by the examiner, processing continues optionally at the operation 70 or at the operation 72 to execute the simulation instance to define simulation results for the next question or questions if the examination is organized into checkpoints. Execution of the simulation may include an additional examinee decision as indicated if processing continues at the operation 70. In an alternative embodiment, the simulation instance is executed for each question in the examination template. If the current checkpoint is the last checkpoint defined by the examiner, processing of the examination stops in an operation 88.

FIG. 5 illustrates an exemplary examination process of the examinee interface application 34 executing at one of the examinee devices 24a-24c. Additional, fewer, or different operations may be performed in the process depending on the embodiment. In an operation 90, the examination is engaged when the examinee information is sent from the examinee device 24 to the examination delivery program 32. A determination is made at operation 92 relative to whether or not the access to an examination is successful. If the access is unsuccessful, in an operation 94, the examinee information is requested from the examinee. For example, if the examinee information is not found in the operation 64 of FIG. 4, an error message is received and presented to the examinee with a request for the examinee information. In an operation 96, the examinee information is received from the examinee and processing continues at operation 90.

If the access is successful, in an operation 98, the situation sent from the examination delivery program 32 is received and presented to the examinee. In an operation 100, the decision of the examinee to the situation is received. For example, the situation may be presented to the examinee using a display. The examinee decision may be, for example, a selection using a mouse or a touch screen display. In an operation 102, the examinee decision is sent to the examination delivery program 32. In an operation 104, the question is received from the examination delivery program 32. In an operation 106, the received question is presented to the examinee for an answer. For example, the question may be displayed to the examinee using a display or may be played to the examinee using a speaker. In an operation 108, the answer is received from the examinee. For example, the examinee may select a response from the display using an input interface such as a keyboard, a microphone, or a touch screen display. In an operation 110, the received answer is sent to the examination delivery program 32. A determination is made in an operation 112 concerning whether or not the examination question is the last question. If the determination is that the examination question is the last question, execution of the examinee interface application 34 is stopped in an operation 114. If the determination is that the examination question is not the last question, the next question is received from the examination delivery program 32 and processing continues at operation 104.

Examination questions for the examination simulation can be created using the process as shown with reference to FIG. 6. Additional, fewer or different steps and/or operations may be taken or performed. In an operation 140, an examiner describes a question in a general way. In an operation 142, the described question is designed for implementation within the context of the examination delivery program 32. For example, input parameters are selected, the basic question text is described, etc. In an operation 144, the question subprogram is developed for the designed question. The question subprogram includes data links to the simulation 37.

As with any computer code, the developed question subprogram is tested to insure proper operation within the examination deliver program 32. In an operation 146, a test is defined for the question subprogram. One or more test scenario is defined for the question subprogram as part of the defined test. In an exemplary embodiment, the defined test includes ten standardized development scenarios. Each standardized scenario has previously designed student decisions and known outcomes. The ten scenarios cover the range of potential decisions that could be offered by students during an actual simulation run. Therefore, the designer can determine how the question responds over a range of conditions within the simulation 37. In an operation 148, a standardized development scenario is selected for the question subprogram. In an operation 150, the selected test scenario is executed to define an examination question. The defined examination question is stored to the database 30 in an operation 152. For example, the defined examination question may be saved for review by an examiner later and for selection into an examination template. A determination of whether or not another test scenario is to be executed is made in an operation 154. If another test scenario is to be executed, processing continues at operation 148.

If the test is completed, in an operation 156, the defined examination question from each test scenario is validated. A determination of whether or not the defined examination question(s) is validated is made in an operation 158. If the defined examination question(s) is not validated, processing continues at either operation 142 or 144 depending on the issues identified relative to the question during the validation process. If the defined examination question(s) is validated, in an operation 160, the examiner evaluates the defined examination question(s) to insure that the question poses the question as described in the operation 140. If the defined examination question(s) is not approved in an operation 162, processing continues at operation 140 with a revised description of the question or clarification of the question.

If the defined examination question(s) is approved in an operation 162, the question subprogram may be locked. Several iterations of the described process may be required to perfect the question before it is locked in an operation 164. The question is “locked” from future change because it will begin to accumulate statistics as soon as it is incorporated into an examination. For example, the examination simulation system 20 can track how many students answered the question, how many got it right, and what wrong answers were selected. A locked question may spawn a descendant question (a new alternative question or replacement question), but the original question remains permanently associated with the edition of the examination. For example, if the examination is conducted for a certification process or a competency determination, it is important to fix the various editions for review later and for possible accreditation of the examination. In an operation 166, the approved question subprogram is stored into the database 30 and becomes available for selection in an examination template by an examiner. The question may be associated with a plurality of examinations.

With reference to FIG. 7, the process of creating an examination is depicted. For example, new editions of a competency examination can be developed each year. Questions from earlier editions must be re-examined, validated, and approved before the new simulation and scenario are used. In an operation 170, a question description is selected from the database 30. In an operation 172, the selected examination question is evaluated by the examiner. For example, the examiner examines the defined examination question(s) saved in operation 152 of FIG. 6. If the selected examination question is not approved in an operation 174, processing continues at operation 182. If the selected examination question is approved in the operation 174, the selected examination question is added to the examination template in an operation 176. If a determination to select another question is made in an operation 178, processing continues at operation 170. If no additional examination questions are to be added to the examination template, the examination template is named and stored in the database 30 in an operation 180. Examinees can be registered to take the examination in an operation 182.

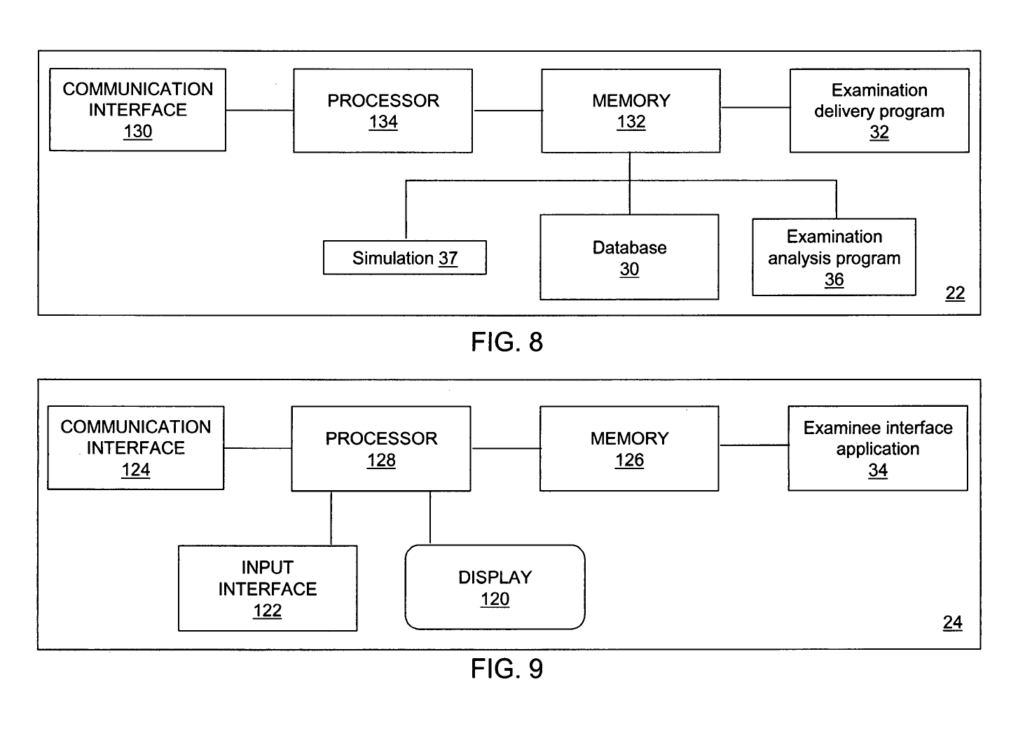

With reference to FIG. 8, the first device 22 can include a communication interface 130, a memory 132, a processor 134, the examination delivery program 32, the database 30, the simulation 37, and the examination analysis program 36. Different and additional components may be incorporated into the first device 22. The communication interface 130 provides an interface for receiving and transmitting information communicable between devices. Communications between the first device 22, the examinee device 24, and the examiner device 26 may be through various wired or wireless connection methods and media and using various transmission technologies. The device 22 may have one or more communication interface 130 that uses the same or a different communication technology.

The memory 132 stores the examination delivery program 32, the database 30, the simulation 37, and the examination analysis program 36. The device 22 may have one or more memory 132 that uses the same or a different memory technology. Memory technologies include, but are not limited to, RAM, Read Only Memory, flash memory, etc.

The processor 134 executes instructions that cause the device 22 to behave in a predetermined manner. The instructions may be written using one or more programming language, scripting language, assembly language, etc. Additionally, the instructions may be carried out by a special purpose computer, logic circuits, or hardware circuits. Thus, the processor 134 may be implemented in hardware, firmware, software, or any combination of these methods. The term “execution” is the process of running a program or the carrying out of the operation called for by an instruction. The processor 134 executes an instruction, meaning that it performs the operations called for by that instruction. The processor 134 couples to the communication interface 130, for example, to relay received information from the examiner device 26 to the examination delivery program 32 or to send information from the examination delivery program 32 to another device such as the examinee device 24. The device 22 may have one or more processor 134 that uses the same or a different processing technology.

The examination delivery program 32 is an organized set of instructions that, when executed, cause the device 22 to perform some or all of the operations depicted with reference to FIGS. 4, 6, and 7. The examination delivery program 32 may be written using one or more programming languages, assembly languages, scripting languages, etc.

In an exemplary embodiment, the database 30 contains data for the examination delivery program 32. The database 30 may be configured to save and to access data items or records in a variety of forms as known to those skilled in the art including a spreadsheet, a database, a text file, for example, formatted using the extensible markup language, etc. The device 22 may include one or more database 30.

With reference to FIG. 9, the examinee device 24 can include a display 120, an input interface 122, a communication interface 124, a memory 126, a processor 128, and the examinee interface application 34. Different and additional components may be incorporated into the examinee device 24. The display 120 presents information to a user. The display 120 may be a thin film transistor display, a light emitting diode display, a Liquid Crystal Display, or any of a variety of different displays known to those skilled in the art now or in the future.

The input interface 122 provides an interface for receiving information from the user for entry into the device 24. The input interface 122 may use various input technologies including, but not limited to, a keyboard, a pen and touch screen, a mouse, a track ball, a touch screen, a keypad, one or more buttons, or any of a variety of different displays known to those skilled in the art now or in the future to allow the user to enter information into the device 24 or to make selections. The input interface 122 may provide both an input and an output interface. For example, a touch screen both allows user input and presents output to the user. The device 24 may have one or more input interface 122 that uses the same or a different technology.

The communication interface 124 provides an interface for receiving and transmitting information communicable between devices. The device 24 may have one or more communication interface 124 that uses the same or a different communication technology. The memory 126 stores the examinee interface application 34. The device 24 may have one or more memory 126 that uses the same or a different memory technology.

The processor 128 couples to the communication interface 124 to relay received information from another device to the examinee interface application 34 or to send information from the examinee interface application 34 to another device such as the first device 22. The device 24 may have one or more processor 128 that uses the same or a different processing technology.

The examinee interface application 34 is an organized set of instructions that, when executed, cause the device 24 to perform some or all of the operations depicted with reference to FIG. 5. The examinee interface application 34 may be written using one or more programming languages, assembly languages, scripting languages, etc. In an exemplary embodiment, the examinee interface application 34 may be a web browser as known to those skilled in the art.

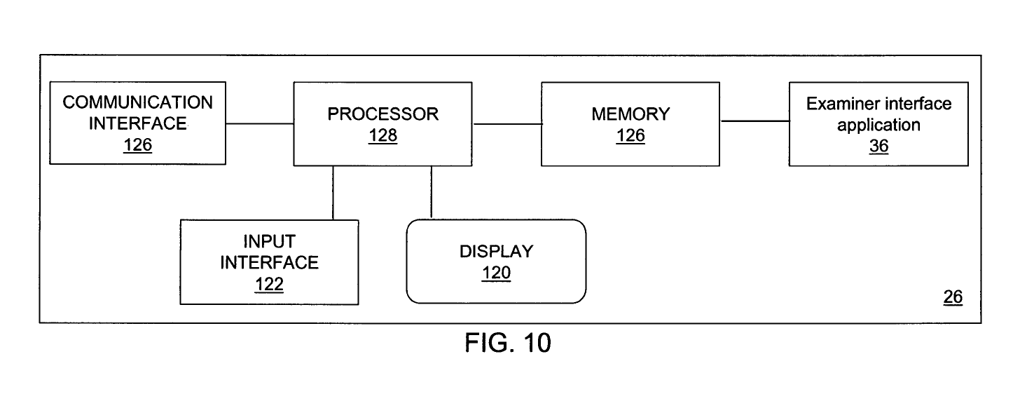

With reference to FIG. 10, the examiner device 26 can include a display 120, an input interface 122, a communication interface 124, a memory 126, a processor 128, and the examiner interface application 36. Different and additional components may be incorporated into the examiner device 26. The examiner interface application 36 is an organized set of instructions that, when executed, cause the device 26 to perform some or all of the operations depicted with reference to FIGS. 6 and 7. The examiner interface application 36 may be written using one or more programming languages, assembly languages, scripting languages, etc. In an exemplary embodiment, the examiner interface application 36 may be a web browser as known to those skilled in the art.

Advantageously, the examination simulation system 20 applies to most courses in a curriculum. For example, in an accounting course, the simulation focus may be on financial statements and ratios. Alternatively, in a business course, the simulation focus may be management strategy.

The foregoing description of exemplary embodiments of the invention have been presented for purposes of illustration and of description. It is not intended to be exhaustive or to limit the invention to the precise form disclosed, and modifications and variations are possible in light of the above teachings or may be acquired from practice of the invention. The exemplary embodiments (which can be practiced separately or in combination) were chosen and described in order to explain the principles of the invention and as practical applications of the invention to enable one skilled in the art to utilize the invention in various embodiments and with various modifications as suited to the particular use contemplated. The functionality described may be implemented in a single executable or application or may be distributed among different modules without deviating from the spirit of the invention. Additionally, the order of execution of the operations described may be changed without deviating from the spirit of the invention. It is intended that the scope of the invention be defined by the claims appended hereto and their equivalents. Thus, the description of the preferred embodiments is for purposes of illustration and not limitation.

What is claimed is:

1. A method for conducting an examination utilizing a simulation, the method comprising:
(a) granting an examinee access to an examination selected for the examinee based on examinee information entered by the examinee, the examination including a question subprogram;
(b) creating a simulation for the examinee based on the selected examination;
(c) presenting a situation to the examinee using the created simulation;
(d) requesting an examinee decision relative to the presented situation;
(e) executing the created simulation using the examinee decision as an input thereby calculating a result;
(f) executing the question subprogram using the calculated result thereby defining a question;
(g) sending the defined question to the examinee; and
(h) receiving an answer to the sent question from the examinee, the answer selected by the examinee.

2. The method of claim 1, further comprising (i) storing the received answer in a database.

3. The method of claim 2, further comprising repeating (f)-(i) for a plurality of question subprograms.

4. The method of claim 3, wherein executing the question subprogram further includes using one or more stored answer.

5. The method of claim 2, further comprising repeating (e)-(i) for a plurality of question subprograms.

6. The method of claim 5, wherein executing the created simulation further includes using one or more stored answer.

7. The method of claim 1, wherein executing the question subprogram further defines a plurality of potential answers, and further wherein sending the defined question includes sending the plurality of potential answers.

8. The method of claim 7, wherein the received answer is one of the plurality of potential answers.

9. The method of claim 7, wherein the plurality of potential answers are defined based on a common mistake made by the examinee when determining the answer.

10. The method of claim 7, wherein the plurality of potential answers are sent in a random order.

11. The method of claim 1, further comprising storing the examinee decision in the database.

12. The method of claim 1, further comprising determining if the received answer is correct and storing the determination in the database.

13. The method of claim 1, further comprising granting access to the simulation using a key.

14. The method of claim 13, wherein the key is a unique string created using the examinee information.

15. The method of claim 1, wherein the simulation is a business simulation.

16. At least one computer-readable medium having computer-readable instructions stored thereon that, upon execution by a processor, cause the processor to conduct an examination utilizing a simulation, the instructions:
(a) granting an examinee access to an examination selected for the examinee based on examinee information entered by the examinee, the examination including a question subprogram;
(b) creating a simulation for the examinee based on the selected examination;
(c) presenting a situation to the examinee using the created simulation;
(d) requesting an examinee decision relative to the presented situation;
(e) executing the created simulation using the examinee decision as an input thereby calculating a result;
(f) executing the question subprogram using the calculated result thereby defining a question;
(g) sending the defined question to the examinee; and
(h) receiving an answer to the sent question from the examinee, the answer selected by the examinee.

17. A device for conducting an examination utilizing a simulation, the device comprising:
an examination delivery program, the examination delivery program including computer code
(a) to grant an examinee access to an examination selected for the examinee based on examinee information entered by the examinee, the examination including a question subprogram;
(b) to create a simulation for the examinee based on the selected examination;
(c) to present a situation to the examinee using the created simulation;
(d) to request an examinee decision relative to the presented situation;
(e) to execute the created simulation using the examinee decision as an input thereby calculating a result;
(f) to execute the question subprogram using the calculated result thereby defining a question;
(g) to send the defined question to the examinee; and
(h) to receive an answer to the sent question from the examinee, the answer selected by the examinee;
a memory, wherein the memory stores the examination delivery program; and
a processor coupled to the memory, the processor executing the examination delivery program.

18. The device of claim 17, further comprising a communication interface, wherein the communication interface receives the examinee information from the examinee using a network, sends the defined question to the examinee using the network, and receives the answer from the examinee using the network.

19. A method for taking an examination utilizing a simulation, the method comprising:
(a) sending examinee information from an examinee to an examination delivery program, wherein an examination is selected based on the examinee information;
(b) presenting a situation to the examinee, wherein the situation is created by the examination delivery program using a simulation, the simulation created based on the selected examination;
(c) sending an examinee decision to the examination delivery program, wherein the examinee decision is a response to the situation;
(d) receiving a question from the examination delivery program, the question defined by the examination delivery program through execution of a question subprogram, wherein execution of the question subprogram uses a result calculated by the simulation using the examinee decision as an input;
(e) presenting the received question to the examinee; and
(f) sending an answer to the presented question to the examination delivery program.

20. At least one computer-readable medium having computer-readable instructions stored thereon that, upon execution by a processor, cause the processor to present an examination utilizing a simulation to an examinee, the instructions:
(a) sending examinee information from an examinee to an examination delivery program, wherein an examination is selected based on the examinee information;
(b) presenting a situation to the examinee, wherein the situation is created by the examination delivery program using a simulation, the simulation created based on the selected examination;
(c) sending an examinee decision to the examination delivery program, wherein the examinee decision is a response to the situation;
(d) receiving a question from the examination delivery program, the question defined by the examination delivery program through execution of a question subprogram, wherein execution of the question subprogram uses a result calculated by the simulation using the examinee decision as an input;
(e) presenting the received question to the examinee; and
(f) sending an answer to the presented question to the examination delivery program.

21. A device for presenting an examination utilizing a simulation to an examinee, the device comprising:
an examinee interface application, the examinee interface application comprising computer code
(a) to send examinee information from an examinee to an examination delivery program, wherein an examination is selected based on the examinee information;
(b) to present a situation to the examinee, wherein the situation is created by the examination delivery program using a simulation, the simulation created based on the selected examination;
(c) to send an examinee decision to the examination delivery program, wherein the examinee decision is a response to the situation;
(d) to receive a question from the examination delivery program, the question defined by the examination delivery program through execution of a question subprogram, wherein execution of the question subprogram uses a result calculated by the simulation using the examinee decision as an input;
(e) to present the received question to the examinee; and
(f) to send an answer to the presented question to the examination delivery program;
a display, wherein the display presents the question to the examinee;
an input interface, wherein the input interface allows the examinee to respond to the presented question;
a memory, wherein the memory stores the examinee interface application; and
a processor coupled to the display, the input interface, and the memory, the processor executing the examinee interface application.

22. The device of claim 21, further comprising a communication interface, wherein the communication interface sends the examinee information using a network and receives the question using the network.

23. A system enabling an administration of an examination, which utilizes a simulation, to a plurality of examinees, the system comprising:
a first device, the first device comprising
an examination delivery program, the examination delivery program including computer code
(a) to grant an examinee access to an examination selected for the examinee based on examinee information entered by the examinee, the examination including a question subprogram;
(b) to create a simulation for the examinee based on the selected examination;
(c) to present a situation to the examinee using the created simulation;
(d) to request an examinee decision relative to the presented situation;
(e) to execute the created simulation using the examinee decision as an input thereby calculating a result;
(f) to execute the question subprogram using the calculated result thereby defining a question;
(g) to send the defined question to the examinee; and
(h) to receive an answer to the sent question from the examinee, the answer selected by the examinee;
a first memory, wherein the first memory stores the examination delivery program;
a first communication interface, wherein the first communication interface receives the examinee information from the examinee using a network, sends the defined question to the examinee using the network, and receives the answer from the examinee using the network; and
a first processor coupled to the first memory and to the first communication interface, the processor executing the examination delivery program; and
a second device, the second device comprising
an examinee interface application, the examinee interface application comprising computer code
(i) to send the examinee information from the examinee to the examination delivery program;
(j) to present the situation to the examinee;
(k) to send the examinee decision to the examination delivery program;
(l) to receive the defined question from the examination delivery program;
(m) to present the received question to the examinee; and
(n) to send the answer to the presented question to the examination delivery program;
a display, wherein the display presents the question to the examinee;
an input interface, wherein the input interface allows the examinee to select the answer;
a second communication interface, wherein the second communication interface sends the examinee information using the network and receives the question using the network;
a second memory, wherein the second memory stores the examinee interface application; and
a second processor coupled to the display, the input interface, the second communication interface, and the second memory, the second processor executing the examinee interface application.

24. A method for creating a dynamic question used in an examination utilizing a simulation, the method comprising:
(a) developing a question subprogram for a question, wherein the question subprogram creates the examination question using results calculated through execution of a simulation, the results inserted in the question during the examination;
(b) testing the question subprogram using a scenario to define a question;
(c) validating the question subprogram based on a validation of the defined question; and
(d) if the question subprogram is validated, storing the question subprogram in a database.

25. The method of claim 24, further comprising, if the question subprogram is validated, locking the question subprogram to prevent modification of the question subprogram.

26. The method of claim 24, further comprising repeating (a)-(d) for a plurality of questions.

27. The method of claim 26, further comprising organizing the plurality of questions into an examination template.

28. The method of claim 26, wherein the plurality of questions are organized by at least one of a topic, an author, and an edition.

29. The method of claim 24, further comprising defining a question description associated with the question.

30. The method of claim 24, wherein the question description includes at least one of a unique identifier, a text description of the question, a text description of a question purpose, and a recommendation for usage of the question in an examination.

31. A method for creating an examination that utilizes a simulation, the method comprising:
selecting a question from a database including a plurality of examination questions, wherein the question is defined using a question subprogram, and further wherein the question subprogram creates the question using results calculated through execution of a simulation; and
adding the question to an examination template based on an evaluation of the question.

32. The method of claim 31, further comprising editing the question to create a new question and storing the new question in the database.

33. The method of claim 31, further comprising editing the question subprogram to create a new question and storing the edited question subprogram and the new question in the database.

34. The method of claim 33, further comprising associating the new question with the question.

35. The method of claim 31, further comprising storing the examination template in the database.
